(19) United States
(12) Patent Application Publication
(10) Pub. No.: US 2010/0078840 A1
(43) Pub. Date: Apr. 1, 2010

(54) IMPRINT APPARATUS AND METHOD OF MANUFACTURING ARTICLE

(75) Inventors: Eigo Kawakami, Utsunomiya-shi (JP); Hideki Ina, Tokyo (JP); Junichi Seki, Yokohama-shi (JP); Atsunori Terasaki, Kawasaki-shi (JP); Shingo Okushima, Kawasaki-shi (JP); Motoki Okinaka, Inagi-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/565,664

(22) Filed: Sep. 23, 2009

(30) Foreign Application Priority Data
Sep. 25, 2008 (JP) 2008-246332

(51) Int. Cl. B29C 59/02

(52) U.S. Cl. 264/40.1; 425/150

(57) ABSTRACT

An apparatus for pressing resin on a shot region of a substrate and a mold to each other to form a resin pattern on the shot region, including: a mold chuck; an X-Y stage including a substrate chuck, the resin held by the substrate chuck and mold held by the mold chuck being pressed to each other in a Z-axis direction; a dispenser for dispensing the resin on the shot region; a scope for measuring, in an X-Y plane, a position of a substrate mark formed in each of a plurality of shot regions of the substrate held by the substrate chuck; and a reference mark formed on the X-Y stage. The X-Y stage has a moving range allowing the dispenser to dispense the resin on all shot regions of the substrate, and the position of the reference mark can be measured within the moving range of the X-Y stage.

### BACKGROUND OF THE INVENTION

1. Field of the Invention

The present invention relates to an imprint apparatus for pressing resin on a shot region on a substrate and a mold to each other to form a resin pattern on the shot region.

2. Description of the Related Art

There is known nanoimprinting, which is a technique replacing a method of forming fine patterns of semiconductor devices and micro electro-mechanical systems (MEMS) by photolithography using ultraviolet rays, X-rays, and electron beams. In the nanoimprinting, a mold (also referred to as a template or original) having fine patterns formed by exposure with an electron beam is pressed against (imprinted onto) a substrate, such as a wafer, coated with a resin material to transfer the patterns to the resin.

There are several types of nanoimprinting, and one of those is a photo-curing method (U.S. Pat. No. 7,027,156). In the photo-curing method, a transparent mold is pressed against a UV-curable resin, and the mold is separated (released) after the resin is exposed and cured. The nanoimprinting using the photo-curing method is suitable for the manufacture of semiconductor integrated circuits because the temperature control is relatively easy and an alignment mark on the substrate can be observed through the transparent mold.

Although there is a method in which a pattern is transferred to the entire surface of the substrate at a time, taking into consideration the case where different patterns are superposed, a step-and-repeat method is to be employed, in which a mold having substantially the same size as the chip of the device to be manufactured is fabricated and the pattern thereon is successively transferred to the shot regions on the substrate.

In addition, a suitable one of a die-by-die method is used, in which the alignment is performed on each shot region, and a global alignment method, depending on the alignment accuracy of the shot regions and the throughput.

In such a nanoimprint apparatus, resin is coated on a substrate using a dispenser head, which is a discharge unit for discharging a UV-curable resin (hereinafter, “resin”).

The dispenser head has discharging nozzles that are linearly arranged over a length greater than the width of a shot region, and discharges resin onto each shot region on the substrate, while scanning a substrate stage carrying a substrate.

Alternatively, resin is coated on a substrate using a dispenser head having discharging nozzles arranged in a matrix and capable of discharging the resin at a time onto the entirety of a shot region, after the substrate stage carrying the substrate is moved to bring the target shot region beneath the dispenser head.

Accordingly, in order to coat all shot regions on the substrate with resin, the substrate stage (X-Y stage) is to have a stroke equivalent to at least the outer diameter of the substrate.

On the other hand, if pattern transfer is performed using the global alignment method, after the mold is installed on a mold chuck serving as a mold holding unit or mold holder, moving directions of the substrate stage (two orthogonal axes) are aligned with the two orthogonal axes, which serve as the reference on the surface of the mold having the pattern.

At this time, using a reference mark on the substrate stage and an alignment mark on the mold, the direction of the mold (directions of the aforementioned two axes) is adjusted.

Thus, the stroke over which the substrate stage is driven to bring the reference mark on the substrate stage beneath a plurality of alignment marks of the mold is to be considered.

The stroke may be too large depending on the arrangement of the dispenser and the arrangement of the reference mark on the X-Y stage. Such a large stroke may be disadvantageous in footprint of the imprint apparatus.

### SUMMARY OF THE INVENTION

The present invention provides an apparatus for pressing resin on a shot region of a substrate and a mold to each other to form a resin pattern on the shot region, the apparatus including: a mold chuck; an X-Y stage including a substrate chuck, the resin held by the substrate chuck and the mold held by the mold chuck being pressed to each other in a Z-axis direction; a dispenser configured to dispense the resin on the shot region; a scope configured to measure, in an X-Y plane, a position of a substrate mark formed in each of a plurality of shot regions of the substrate held by the substrate chuck; and a reference mark formed on the X-Y stage, wherein the X-Y stage has a moving range allowing the dispenser to dispense the resin on all shot regions of the substrate, and the reference mark is arranged at a position on the X-Y stage where the position of the reference mark can be measured within the moving range of the X-Y stage.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 shows a structure of an imprint apparatus according to a first embodiment of the present invention.

FIG. 2 is a control block diagram of the imprint apparatus according to the first embodiment.

FIG. 3 is a plane view of a fine-motion stage according to the first embodiment.

FIGS. 4A to 4D are side views of the fine-motion stage according to the first embodiment.

FIG. 5 is a plane view of a fine-motion stage according to a second embodiment of the present invention.

FIG. 6 is a plane view of a fine-motion stage according to a third embodiment of the present invention.

FIG. 7 is a plane view of a fine-motion stage according to a fourth embodiment of the present invention.

FIG. 8 is a flowchart of a process of successively transferring a pattern of a layer to a plurality of wafers.

FIG. 9 is a detailed flowchart of a process of transferring a pattern to one wafer.

FIG. 10 shows an arrangement of sample shot regions for global alignment measurement.

FIG. 11 is a cross-sectional view of the vicinity of a mold chuck, showing an arrangement of alignment marks.

FIG. 12 shows a positional relationship between alignment marks in the field of view of TTM alignment scopes.

FIG. 13 is a plane view of a fine-motion stage for according to one embodiment of the present invention.

FIGS. 14A to 14D are side views of the fine-motion stage according to one embodiment of the present invention.

### DESCRIPTION OF THE EMBODIMENTS

Referring to the attached drawings, a nanoimprint apparatus (imprint apparatus) using a photo-curing method according to embodiments of the present invention will be described.

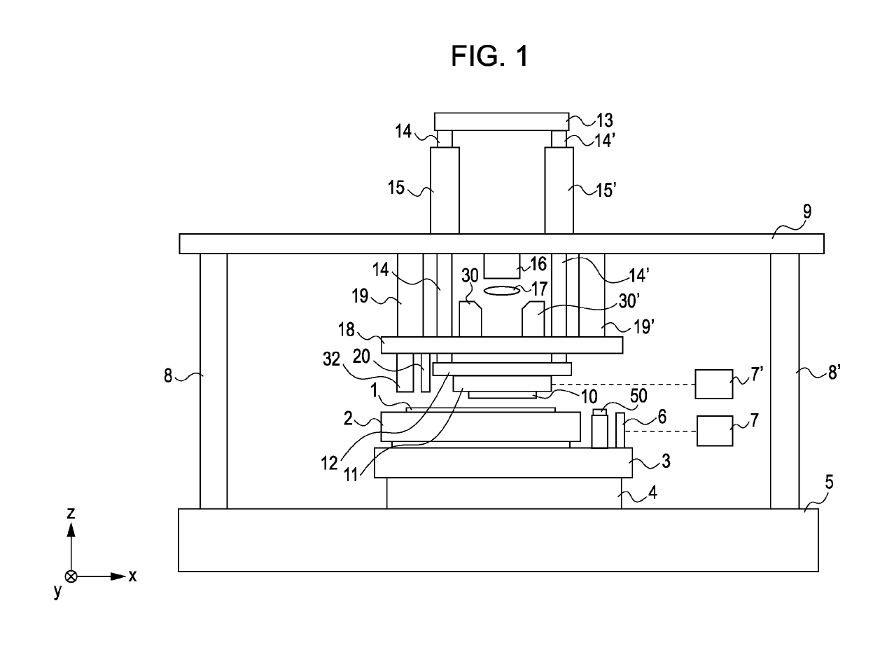

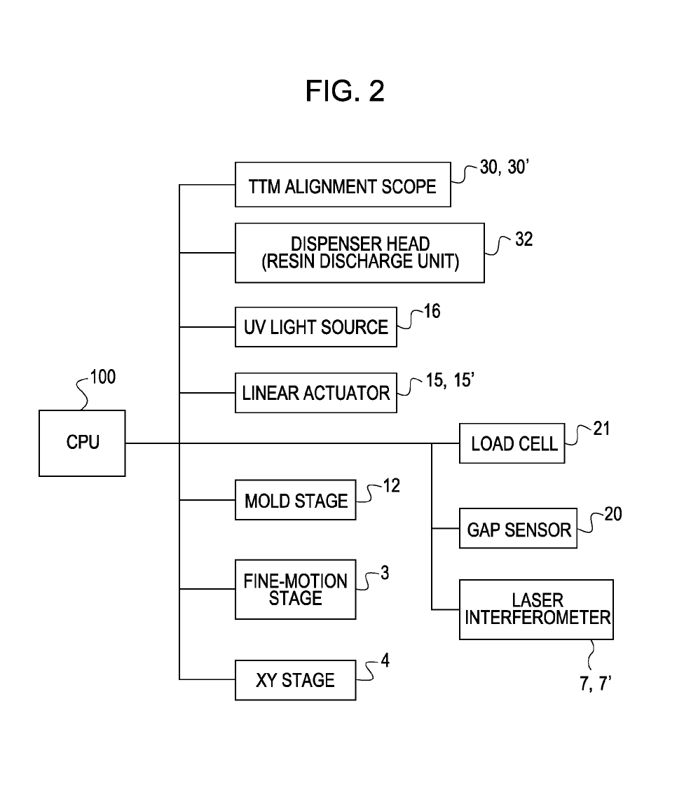

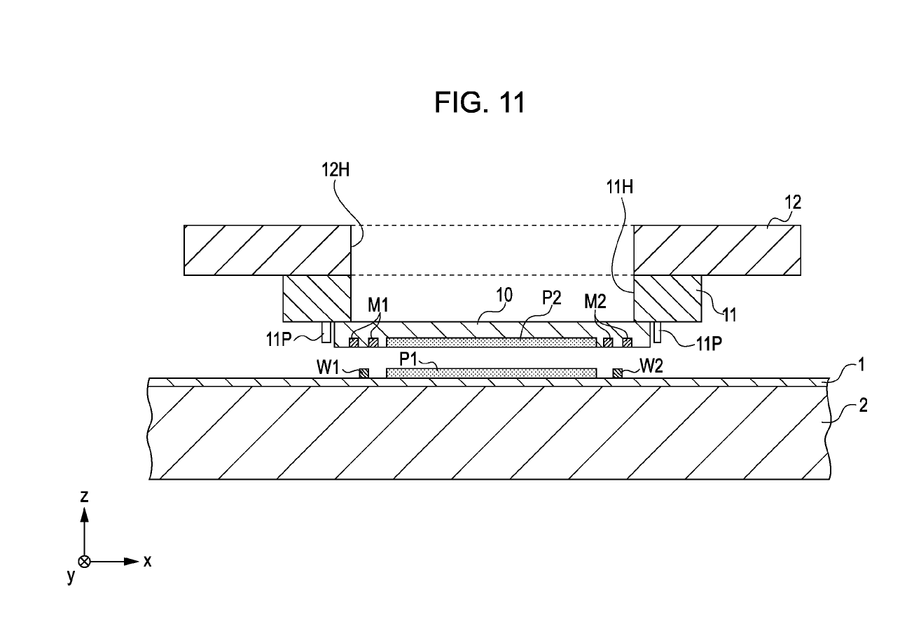

FIG. 1 shows a structure of an imprint apparatus according to a first embodiment of the present invention. FIG. 2 is a control block diagram of the imprint apparatus according to the first embodiment. FIG. 11 is a cross-sectional view of the vicinity of a mold chuck, showing the arrangement of alignment marks according to the first embodiment.

FIGS. 1, 2, and 11 show a wafer 1, serving as a substrate, a wafer chuck 2 (also referred to as a “substrate chuck”) for holding the wafer 1, and a fine-motion stage 3 having a function for correcting the position in the θ (rotation about the Z-axis) direction of the wafer 1, a function for adjusting the z position of the wafer 1, and a tilt function for correcting the inclination of the wafer 1. The fine-motion stage 3 is disposed on an XY stage 4 for bringing the wafer 1 to a predetermined position. In the following description, the fine-motion stage 3 and the XY stage 4 are collectively called, a substrate stage, a wafer stage, or an X-Y stage.

The XY stage 4 is placed on a base 5. A reference mirror 6 attached to the fine-motion stage 3 reflects light from a laser interferometer 7 to measure the position of the fine-motion stage 3 in the x and y directions (y direction is not shown). Posts 8 and 8′ standing upright on the base 5 support a top board 9.

A mold 10 has, on the surface thereof, a protruding and recessed pattern P2 to be transferred to the wafer 1, and is fixed to a mold chuck 11 by a mechanical holding unit (not shown). Similarly, the mold chuck 11 is placed on a mold stage 12 by a mechanical holding unit (not shown). A plurality of positioning pins 11P restrict the position of the mold 10 on the mold chuck 11, when the mold 10 is installed on the mold chuck 11.

The mold stage 12 has a function for correcting the position in the θ (rotation about the Z-axis) direction of the mold 10 (mold chuck 11) and a tilt function for correcting the inclination of the mold 10. The mold stage 12 has a reflection surface for reflecting light from the laser interferometer 7′ in order to measure the position in the x and y directions (y direction is not shown) thereof. The mold chuck 11 and the mold stage 12 have openings 11H and 12H, respectively, that allow UV rays emitted from a UV light source 16 and passing through a collimating lens 17 to reach the mold 10 and irradiate resin on the wafer 1.

Guide bars 14 and 14′ penetrating the top board 9 are fixed to the mold stage 12 at one end and to a guide bar plate 13 at the other end. Linear actuators 15 and 15′ formed of air cylinders or linear motors drive the guide bars 14 and 14′ in the Z-axis direction in FIG. 1 so as to press the mold 10, which is held by the mold chuck 11, against the wafer 1 or separate the mold 10 from the wafer 1.

An alignment shelf 18 is supported between posts 19 and 19′ so as to be hung from the top board 9, and the guide bars 14 and 14′ penetrate the alignment shelf 18. A gap sensor 20, which is a capacitance sensor or the like, measures the height (flatness) of the wafer 1 on the wafer chuck 2. A plurality of load cells 21 (not shown in FIG. 1) attached to the mold chuck 11 or the mold stage 12 measure the pressing force of the mold 10.

Through-the-mold (TTM) alignment scopes 30 and 30′ are used to measure the alignment. These scopes 30 and 30′ include an optical system and an image-pickup system or a photodetector for measuring the positional deviation between an alignment mark formed on the wafer 1 (also referred to as a substrate mark) and an alignment mark formed on the mold (also referred to as a mold mark). Using the TTM alignment scopes 30 and 30′, the positional deviations in the x and y directions between the wafer 1 and the mold 10 are measured.

A dispenser head (resin discharge unit) 32 has resin drop nozzles for dropping liquid resin on the surface of the wafer 1. The liquid resin may be a photocuring resin.

A reference mark 50 is provided on a reference mark mount disposed on the fine-motion stage 3 (X-Y stage).

A central processing unit (CPU) 100 controls the foregoing actuators and sensors and makes the imprint apparatus perform a predetermined operation.

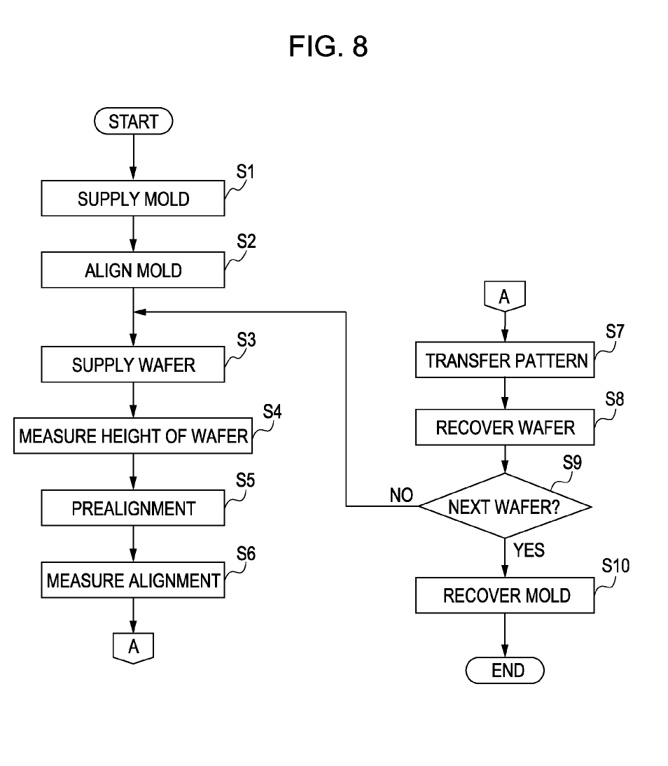

Referring to FIGS. 1 and 8 to 12, operation of the nanoimprint apparatus during fabrication of semiconductor devices will be described. FIG. 8 is a flowchart of a process of transferring a pattern of a layer to a plurality of wafers using the same mold.

In FIG. 8, in step S1, a mold 10 is supplied to a mold chuck 11 by a mold conveying device (not shown).

In step S2, by simultaneously observing alignment marks M1 and M2 on the mold 10, which are shown in FIG. 11, and the reference mark 50 on the fine-motion stage 3 using the TTM alignment scopes 30 and 30′, the positional deviation therebetween is measured.

Then, according to the result of measurement, the mold stage 12 mainly corrects the position of the mold 10 in the θ (rotation about the Z-axis) direction.

Next, in step S3, the wafer 1 is supplied to the wafer chuck 2 by a wafer conveying device (not shown).

In step S4, the XY stage 4 is driven and the height (flatness) of the entire surface of the wafer 1 is measured with the gap sensor 20. As will be described below, this measurement data will be used when the shot surface of the wafer 1 is aligned with the reference plane of the apparatus (not shown) before imprinting.

In step S5, images of a plurality of pre-alignment marks (not shown) previously transferred to the wafer 1 are captured by a pre-alignment measurement device (not shown). Then, the deviation of the plurality of pre-alignment marks in the x and y directions with respect to the apparatus is measured through image processing, and the position of the wafer 1 in the θ (rotation about the Z-axis) direction is corrected according to the result.

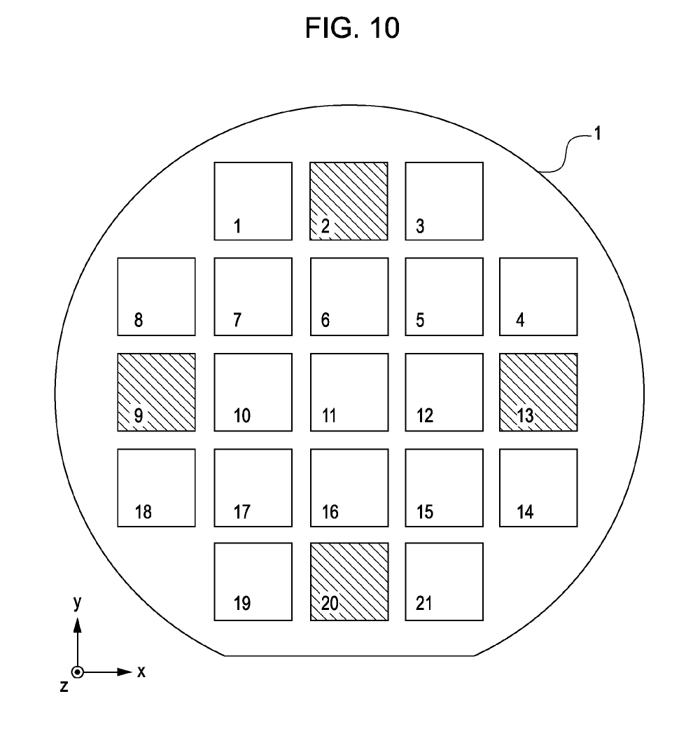

In step S6, measurement using the TTM alignment scopes 30 and 30′ is performed. That is, in sample measurement shot regions, the relative positional deviation in the x and y directions (the positional deviation in the xy plane) between the alignment marks M1 and M2 on the mold (mold marks) and the alignment marks W1 and W2 on the wafer 1 (substrate marks) is measured. The hatched shot regions 2, 9, 13, and 20 in FIG. 10 are the sample measurement shot regions.

In FIG. 11, reference numeral P1 denotes the pattern having been transferred from a preceding layer along with the alignment marks W1 and W2, and reference numeral P2 denotes the pattern on the mold 10.

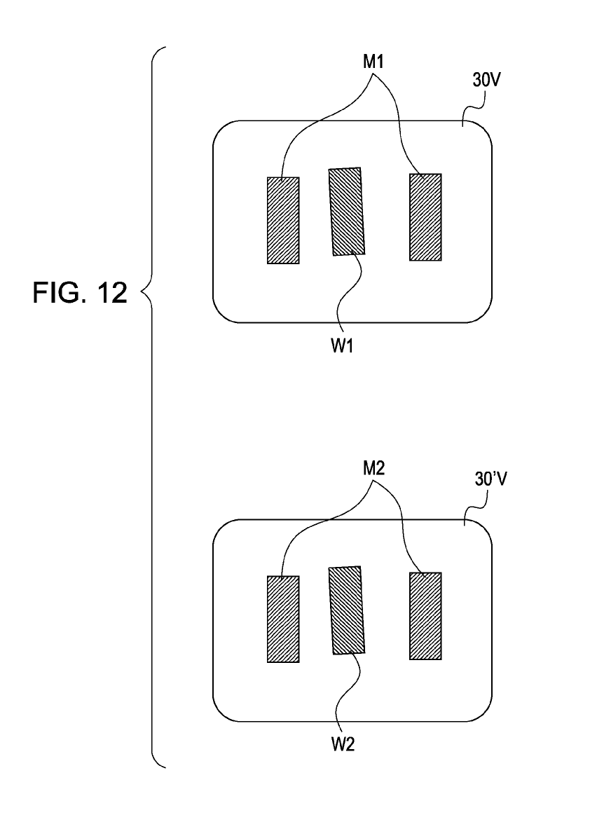

FIG. 12 shows examples of the images of the alignment marks captured by the TTM alignment scopes 30 and 30′ when a method in which the images of the mold marks and substrate marks are simultaneously captured is used. In FIG. 12, fields of view of the TTM alignment scopes 30 and 30′ are denoted by 30V and 30′V, respectively. In this case, only the positional deviation in the x direction can be measured. The positional deviation in the y direction is measured using the alignment marks arranged in the same manner around the patterns P1 and P2 in the y direction. Furthermore, a TTM alignment scope (not shown) for measuring the positional deviation in the y direction is disposed at the corresponding position.

From these positional deviations in the x and y directions, the positional deviation in the θ (rotation about the Z-axis) direction is calculated.

Then, from the result of measurement with the TTM alignment scopes 30 and 30′ in the sample measurement shot regions in FIG. 10, the deviations in the x, y, and θ directions in the shot regions on the wafer 1 are calculated, and the target position of the wafer stage when the pattern is transferred to each shot region is determined. This determination is performed by calculating the coefficient of the expression approximating the coordinates of the measured shot regions through the coordinate transformation of the coordinates of the design shot regions, using the least-squares method or the like.

This is the same method as the global alignment measurement method used in a semiconductor projection exposure apparatus using a step-and-repeat method, which is disclosed in, for example, Japanese Patent No. 03548428.

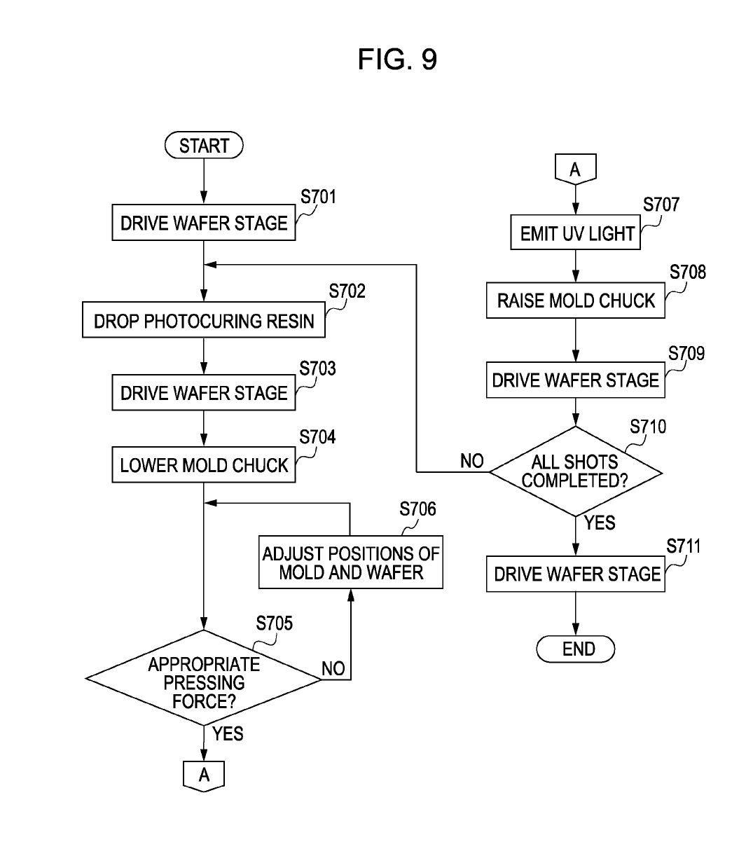

Next, in step S7, the pattern is transferred to each shot region on the wafer 1, as shown in the flowchart in FIG. 9.

When the pattern has been transferred to all shot regions, in step S8, a wafer conveying device (not shown) recovers the wafer 1 from the wafer chuck 2.

In step S9, whether there is a subsequent wafer to be subjected to the pattern transfer is determined. If there is such a wafer (No in step S9), the process returns to step S3, and if there is no such wafer (YES in step S9), the process proceeds to step S10.

In step S10, the mold conveying device (not shown) recovers the mold 10 from the mold chuck 11, thus completing the pattern transfer to the plurality of wafers.

FIG. 9 is a flowchart of a process of transferring a pattern to one wafer with the nanoimprint apparatus according to the first embodiment of the present invention, corresponding to step S7 in FIG. 8.

Referring to FIGS. 9, 1, and 2, the operation and the nanoimprint apparatus according to the first embodiment of the present invention will be described.

In FIG. 9, first, in step S701, the XY stage 4 is driven to move the wafer chuck 2 carrying the wafer 1 and bring the area in the wafer 1 to which a pattern is to be transferred (shot region) beneath the dispenser head 32.

In step S702 (drop photocuring resin), a photocuring resin is dropped onto the target shot region on the wafer 1 with the dispenser head 32.

In the case where the dispenser head 32 has linearly arranged resin discharging nozzles, the resin is discharged while the XY stage 4 is driven in accordance with the size of the shot region.

On the other hand, in the case where the resin discharging nozzles are arranged in a matrix covering the entire surface of the shot region, the XY stage 4 is not to be driven, and the resin can be discharged at a time.

Then, in step S703 (drive wafer stage), the XY stage 4 is driven so as to bring the surface of the shot region to a position facing the pattern P2 on the mold 10. At this time, the position of the wafer stage is determined according to the result of the alignment measurement in step S6 in FIG. 8, and the wafer stage is moved to the target position.

Furthermore, the inclination and the height in the z direction of the wafer chuck 2 are adjusted by the fine-motion stage 3 in accordance with the measurement data of the height of the wafer, and the surface of the shot region of the wafer 1 is aligned with the reference plane (not shown) of the apparatus.

In step S704, the linear actuators 15 and 15′ are driven to lower the mold chuck 11 to a predetermined position.

In step S705, whether the pressing force of the mold 10 is appropriate is determined from the output of the plurality of load cells 21 (not shown) attached to the mold chuck 11 or the mold stage 12. If the pressing force is not within a predetermined range (No in step S705), the process proceeds to S706.

In step S706 (adjust positions of mold or wafer), the pressing force of the mold 10 is adjusted either by changing the position of the mold chuck 11 in the z direction by the linear actuators 15 and 15′ or by changing the position of the wafer chuck 2 in the z direction by the fine-motion stage 3. Steps S705 and S706 are repeated until the intended pressing force is achieved. When the pressing force of the mold 10 is determined to be appropriate in step S705 (YES in step S705), the process proceeds to S707.

In step S707, the UV light source 16 irradiates UV rays for a predetermined period of time.

When the irradiation of the UV rays is completed, in step S708, the linear actuators 15 and 15′ are driven to raise the mold chuck 11, and the mold 10 is separated from the cured resin on the wafer 1.

In step S709, the XY stage 4 is driven to move the wafer 1 and bring the next shot region beneath the dispenser head 32.

In step S710, whether the pattern has been transferred to all shot regions on the wafer 1 is determined.

If there are shot regions to which the pattern has not been transferred (NO in step S710), the process returns to step S702.

If there are no shot regions to which the pattern has not been transferred (YES in step S710), the process proceeds to step S711.

In step S711 (drive wafer stage), the XY stage 4 is moved to a predetermined position for recovery of the wafer (step S8 in FIG. 8).

Although the operation of transferring the pattern to the wafer 1 has been described above with reference to FIG. 9, the pattern transfer can be performed after positioning by the die-by-die alignment method, not by the global alignment method. For example, the die-by-die alignment method is used for the shot regions in the central portion of the wafer, where the alignment accuracy is high. For the shot regions near the periphery of the wafer, where alignment errors seem to be large, pattern transfer may be performed using the global alignment method based on the measurement result by the previously used die-by-die alignment method.

In this case, the die-by-die alignment is performed before or after step S704 in FIG. 9, in such a manner that the amount of positional deviation is measured using a method used for the sample measurement shot regions, which is described above in step S6 in FIG. 8, and the fine-motion stage 3 performs positioning in the x, y, and θ directions.

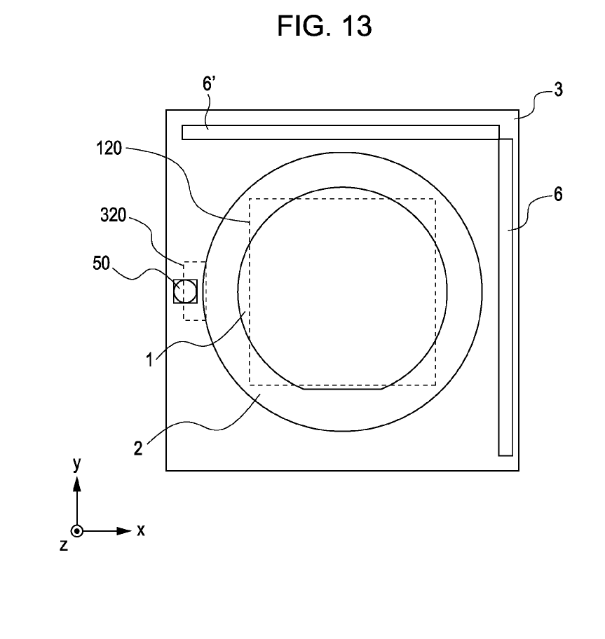

FIG. 13 is a plane view of the fine-motion stage 3 disposed on the XY stage 4, and the components having the same functions as those shown in FIG. 1 are denoted by the same reference numerals, and explanations thereof are omitted.

In FIG. 13, a reference mirror 6′ attached to the fine-motion stage 3 reflects light from a laser interferometer (not shown) to measure the position of the fine-motion stage 3 in the y direction. The dashed line 120 indicates the projection of the mold stage 12 when the center of the mold chuck 11 and the center of the wafer chuck 2 are aligned in the xy plane. The dashed line 320 indicates the projection of the dispenser head 32. In FIG. 13, the reference mark 50 is disposed on the opposite side of the mold chuck 11 with respect to the projection 320 of the dispenser head 32.

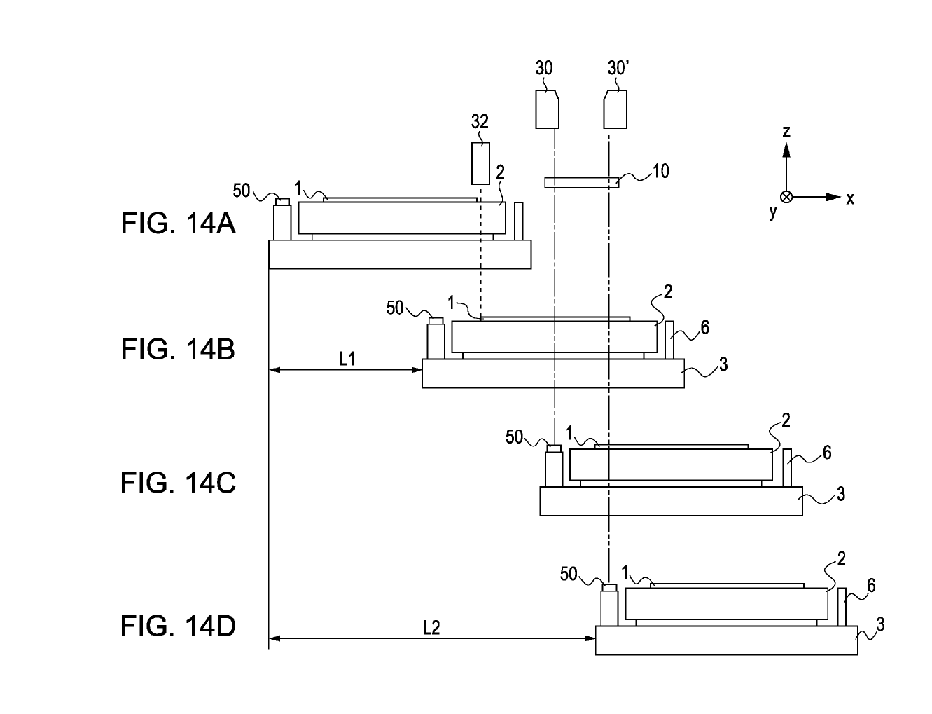

FIGS. 14A to 14D are side views corresponding to FIG. 13, and the components having the same functions as those shown in FIG. 1 are denoted by the same reference numerals, and explanations thereof are omitted. FIGS. 14A to 14D also show the TTM alignment scopes 30 and 30′ and the mold 10.

FIGS. 14A and 14B show a stroke L1 by which the fine-motion stage 3 (that is, the XY stage 4) is to move in the x direction when the dispenser head 32 discharges resin onto all shot regions on the wafer 1.

FIGS. 14C and 14D show the positions of the fine-motion stage 3 at the time of measuring the reference mark 50 on the fine-motion stage 3 using the TTM alignment scopes 30 and 30′ in step S2 in FIG. 8.

As can be seen from FIGS. 14A to 14D, the arrangement in FIG. 13 shows that the fine-motion stage 3 is to move by at least a stroke L2 in the x direction, increasing the footprint of the apparatus. This may result that the apparatus becomes large.

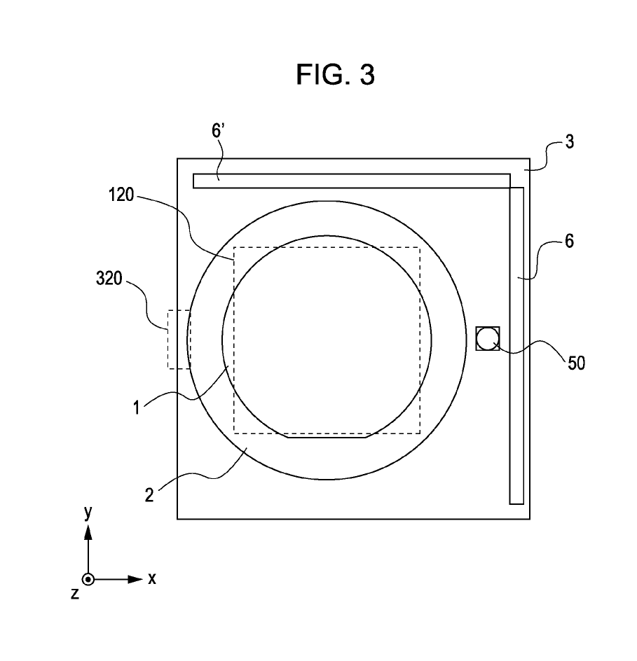

FIG. 3 is a plane view of the fine-motion stage 3 disposed on the XY stage 4, according to the first embodiment of the present invention. The components having the same functions as those shown in FIG. 13 are denoted by the same reference numerals, and explanations thereof are omitted.

FIG. 3 differs from FIG. 13 in that, when the center of the mold chuck 11 and the center of the wafer chuck 2 are aligned in the xy plane, the reference mark 50 is disposed on the same side as the mold chuck 11 with respect to the projection 320 of the dispenser head 32.

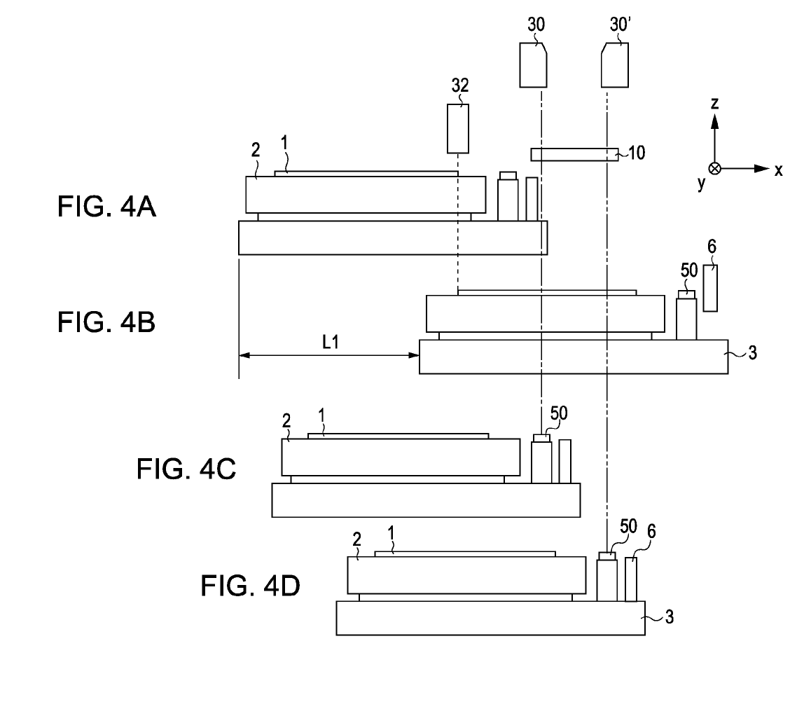

FIGS. 4A to 4D are side views corresponding to FIG. 3, and the components having the same functions as those shown in FIGS. 14A to 14D are denoted by the same reference numerals, and explanations thereof are omitted. Similarly to FIGS. 14A to 14D, FIGS. 4A to 4D also show the TTM alignment scopes 30 and 30′ and the mold 10.

FIGS. 4A and 4B show a stroke L1 by which the fine-motion stage 3 is to move in the x direction when the dispenser head 32 discharges resin onto all shot regions on the wafer 1.

FIGS. 4C and 4D show the positions of the fine-motion stage 3 at the time of measuring the reference mark 50 on the fine-motion stage 3 using the TTM alignment scopes 30 and 30′ in step S2 in FIG. 8.

As can be seen from FIGS. 4A to 4D, the arrangement in FIG. 3 shows that the fine-motion stage 3 is to move in the x direction by a distance equal to the stroke L1, by which the fine-motion stage 3 is to move when the dispenser head 32 discharges resin.

As has been described, when the center of the mold chuck 11 and the center of the wafer chuck 2 are aligned in the xy plane, the reference mark 50 is disposed on the same side as the mold chuck 11 with respect to the dispenser head 32, on the fine-motion stage 3.

As shown in FIGS. 4A to 4D, with the arrangement in FIG. 3, a stroke corresponding to the stroke L2 in FIG. 14D is included in the stroke L1. That is, the X-Y stage moves within a range allowing the dispenser to dispense liquid resin onto all shot regions on the substrate held by the X-Y stage. The reference mark 50 is provided on the X-Y stage, at a position where the positional deviation between the reference mark 50 and the mold mark can be measured with the TTM alignment scopes 30 and 30′ within the moving range of the X-Y stage.

If it is only to make the stroke of the XY stage 4 smaller than the stroke L2 in FIG. 14, the reference mark 50 in FIG. 3 may be disposed closer to the center of the mold chuck 11 than the dispenser on the fine-motion stage. In general, the following arrangement is used in the xy plane. The center of the dispenser is disposed at a position deviated from the center of the mold chuck 11 by a first distance (>0) in a certain direction. The center of the reference mark 50 is disposed at a position deviated in the direction opposite to the aforementioned direction from the position deviated from the center of the substrate chuck by the first distance in the aforementioned direction.

The center of the dispenser means the center of the resin discharge ports provided in the dispenser opposite the substrate, and the resin discharge ports form, for example, a linear or rectangular area having multiple openings (holes). Typically, the projection of the mold chuck 11 on the xy plane is rectangular, and the center of the mold chuck 11 means the center of the rectangular shape. Typically, the projection of the substrate chuck on the xy plane is circular, and the center of the substrate chuck means the center of the circular shape. Typically, the reference mark 50 has a shape consisting of a collection of rectangular mark elements, and the center of the reference mark 50 means the center of the shape.

Because an increase in the stroke of the X-Y stage for the mold alignment measurement (reference mark measurement) for the global alignment measurement can be reduced, a small nanoimprint apparatus with a small footprint can be provided.

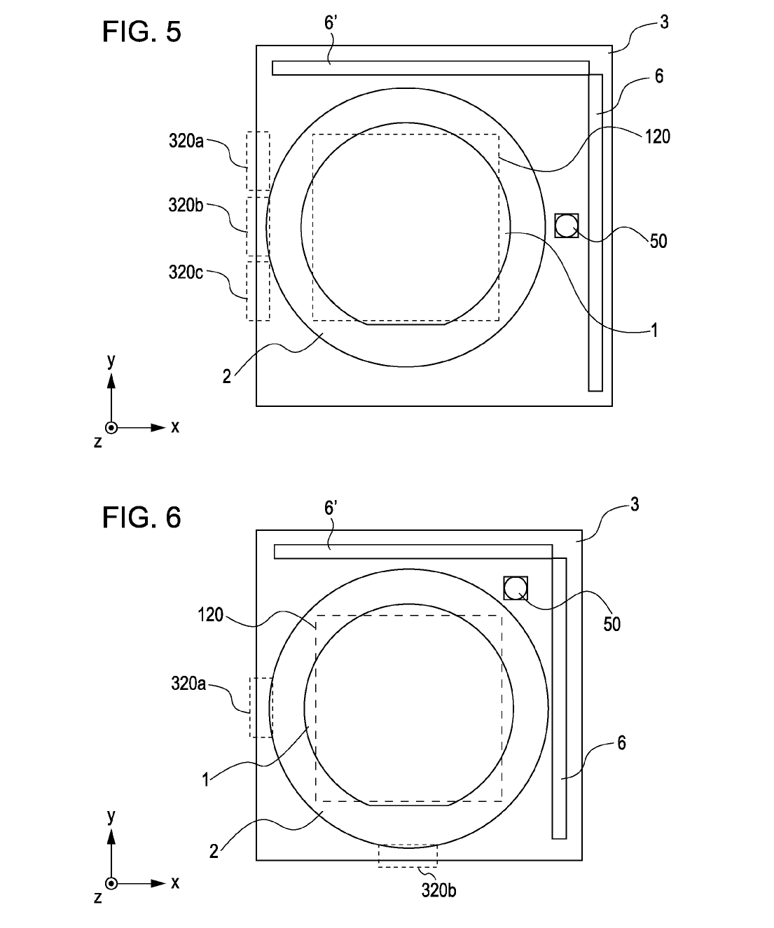

Referring to FIG. 5, the operation and a nanoimprint apparatus according to a second embodiment of the present invention will be described.

FIG. 5 is a plane view of the fine-motion stage 3 disposed on the XY stage 4, showing the case where three dispenser heads are arranged in the y direction to reduce the movement of the XY stage in the y direction for discharge (deposit) of resin. The number of the dispenser heads is not necessarily three, but may be two or more. The components having the same functions as those shown in FIG. 3 are denoted by the same reference numerals, and explanations thereof are omitted.

In FIG. 5, reference numerals 320a to 320c denote the projections of the three dispenser heads for discharging resin while scanning the XY stage 4 in the x direction. In FIG. 5, when the center of the mold chuck 11 and the center of the wafer chuck 2 are aligned in the xy plane, the reference mark 50 is disposed near the center of the mold chuck 11 with respect to the projections 320a to 320c of the three dispenser heads.

The arrangement of FIG. 5 provides the same features as the first embodiment even when the dispenser heads are arranged in a direction perpendicular to the scanning direction of the XY stage 4.

Referring to FIG. 6, the operation a nanoimprint apparatus according to a third embodiment of the present invention will be described.

FIG. 6 is a plane view of the fine-motion stage 3 disposed on the XY stage 4, showing the case where two dispenser heads are disposed at different positions. The components having the same functions as those shown in FIG. 3 are denoted by the same reference numerals, and explanations thereof are omitted.

In FIG. 6, reference numeral 320a denotes the projection of the dispenser head (first dispenser) for discharging resin while scanning the XY stage 4 in the x direction, and reference numeral 320b denotes the projection of the dispenser head (second dispenser) for discharging resin while scanning the XY stage 4 in the y direction.

In FIG. 6, when the center of the mold chuck 11 and the center of the wafer chuck 2 are aligned in the xy plane, the reference mark 50 is disposed near the center of the mold chuck 11 with respect to the projections 320a and 320b of the two dispenser heads. That is, the following arrangement is used in the xy plane. The center of the first dispenser is disposed at a position deviated from the center of the mold chuck 11 by a first distance (>0) in a certain direction. The center of the reference mark 50 is disposed at a position deviated in the direction opposite to the aforementioned direction from the position deviated from the center of the substrate chuck by the first distance in the aforementioned direction. Furthermore, the center of the second dispenser is disposed at a position deviated from the center of the mold chuck 11 by a second distance in a second direction perpendicular to the aforementioned direction. The center of the reference mark 50 is disposed at a position deviated in the direction opposite to the second direction from the position deviated from the center of the substrate chuck by the second distance in the second direction.

The arrangement of FIG. 6 provides the same features as the first embodiment even when the XY stage 4 is driven in the y direction to perform the mold alignment measurement.

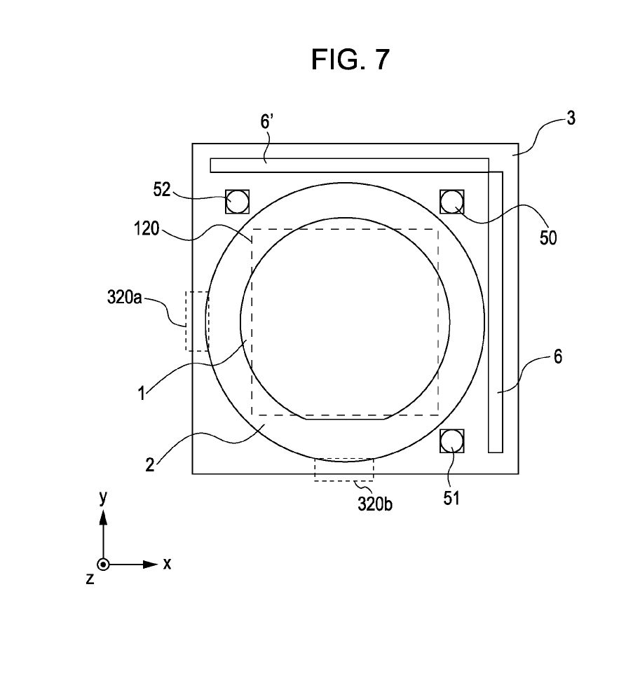

Referring to FIG. 7, the operation and a nanoimprint apparatus according to a fourth embodiment of the present invention will be described.

FIG. 7 is a plane view of the fine-motion stage 3 disposed on the XY stage 4, showing the case where a plurality of reference marks 50 are disposed on the fine-motion stage 3. The components having the same functions as those shown in FIG. 6 are denoted by the same reference numerals, and explanations thereof are omitted.

FIG. 7 shows reference marks 51 and 52, which are the same as the reference mark 50. Reference numeral 320b denotes the projection of the dispenser head for discharging resin while scanning the XY stage 4 in the y direction.

Even in the case where the plurality of dispenser heads are arranged as in FIG. 7, by appropriately arranging the plurality of reference marks for the dispenser heads as described in the first embodiment, an increase in the stroke of the X-Y stage can be restricted as in the third embodiment.

According to the above-described embodiments, it is possible to provide an imprint apparatus having a reduced stroke of the substrate stage (X-Y stage). In addition, it is possible to provide an imprint apparatus with a small footprint and capable of performing global alignment.

A method of manufacturing devices, serving as articles, such as semiconductor integrated circuit elements, liquid crystal display elements, etc., may include a step of transferring (forming) a pattern to a substrate, such as a wafer, a glass plate, a film-like substrate, or the like, using the above-described imprint apparatus, and a step of etching the substrate. When manufacturing other articles, such as patterned media (recording media) and optical elements, a step of processing the substrate may be performed instead of the etching step.

The present invention is industrially applicable in forming fine patterns for manufacturing, for example, the aforementioned articles.

While various embodiments of the present invention have been described above, it is to be understood that the invention is not limited to the disclosed exemplary embodiments. Any modification or variation within the scope of the invention should be possible.

This application claims the benefit of Japanese Patent Application No. 2008-246332 filed Sep. 25, 2008, which is hereby incorporated by reference herein in its entirety.

What is claimed is:

1. An apparatus for pressing resin on a shot region of a substrate and a mold to each other to form a resin pattern on the shot region, the apparatus comprising:
a mold chuck;
an X-Y stage including a substrate chuck, the resin held by the substrate chuck and the mold held by the mold chuck being pressed to each other in a Z-axis direction;
a dispenser configured to dispense the resin on the shot region;
a scope configured to measure, in an X-Y plane, a position of a substrate mark formed in each of a plurality of shot regions of the substrate held by the substrate chuck; and
a reference mark formed on the X-Y stage, wherein
the X-Y stage has a moving range allowing the dispenser to dispense the resin on all shot regions of the substrate, and
the reference mark is arranged at a position on the X-Y stage where the position of the reference mark can be measured within the moving range of the X-Y stage.

2. An apparatus for pressing resin on a shot region of a substrate and a mold to each other to form a resin pattern on the shot region, the apparatus comprising:
a mold chuck;
an X-Y stage including a substrate chuck, the resin held by the substrate chuck and the mold held by the mold chuck being pressed to each other in a Z-axis direction;
a dispenser configured to dispense the resin on the shot region;
a scope configured to measure, in an X-Y plane, a position of a substrate mark formed in each of a plurality of shot regions of the substrate held by the substrate chuck; and
a reference mark formed on the X-Y stage, wherein
the X-Y stage has a moving range allowing the dispenser to dispense the resin on all shot regions of the substrate, and the resin on each shot of the substrate and the mold to be pressed to each other, and
the reference mark is arranged at a position on the X-Y stage where the position of the reference mark can be measured within the moving range of the X-Y stage.

3. An apparatus for pressing resin on a shot region of a substrate and a mold to each other to form a resin pattern on the shot regions of the substrate, the apparatus comprising:
a mold chuck;
an X-Y stage including a substrate chuck, the resin on a shot region of the substrate held by the substrate chuck and the mold held by the mold chuck being pressed to each other in a Z-axis direction;
a first dispenser configured to dispense the resin on the shot regions;
a scope configured to measure, in an X-Y plane, a position of a substrate mark formed in each of a plurality of shot regions of the substrate held by the substrate chuck; and
a first reference mark formed on the X-Y stage, wherein
in the xy plane, a center of the dispenser is disposed at a position deviated from a center of the mold chuck by a first distance (>0) in a first direction, and a center of the reference mark is disposed at a position deviated, from a position deviated from a center of the substrate chuck by the first distance in the first direction, in a direction opposite to the first direction.

4. An apparatus according to claim 3, further comprising a second dispenser configured to dispense the resin on a shot region of the substrate,
wherein the dispenser in claim 3 and the second dispenser are arranged in a direction perpendicular to the first direction.

5. An apparatus according to claim 3, further comprising a second dispenser configured to dispense the resin on a shot region of the substrate, wherein in the X-Y plane, a center of the second dispenser is disposed at a position deviated from the center of the mold chuck by a second distance in a second direction perpendicular to the first direction, and the center of the reference mark is disposed at a position deviated, from a position deviated from the center of the substrate chuck by the second distance in the second direction, in a direction opposite to the second direction.

6. An apparatus according to claim 3, further comprising a second reference mark formed on the X-Y stage.

7. A method comprising:
forming a resin pattern on a shot region of a substrate;
processing the substrate, to which the resin pattern has been formed,
wherein the apparatus is an apparatus for pressing resin on a shot region of a substrate and a mold to each other to form a resin pattern on the shot region, the apparatus including:
a mold chuck;
an X-Y stage including a substrate chuck, the resin on a shot region of the substrate held by the substrate chuck and the mold held by the mold chuck being pressed to each other in a Z-axis direction;
a dispenser configured to dispense resin on the shot region;
a scope configured to measure, in an X-Y plane, a position of a substrate mark formed in each of a plurality of shot regions of the substrate held by the substrate chuck; and
a reference mark formed on the X-Y stage, wherein
the X-Y stage has a moving range allowing the dispenser to dispense resin on all shot regions of the substrate, and
the reference mark is arranged at a position on the X-Y stage where the position of the reference mark can be measured within the moving range of the X-Y stage.

8. A method comprising:
forming a resin pattern on a shot region of a substrate;
processing the substrate, to which the resin pattern has been formed,
wherein the apparatus is an apparatus for pressing resin on a shot region of a substrate and a mold to each other to form a resin pattern on the shot region, the apparatus including:
a mold chuck;
an X-Y stage including a substrate chuck, resin on a shot region of the substrate held by the substrate chuck and the mold held by the mold chuck being pressed to each other in a Z-axis direction;
a dispenser configured to dispense resin on the shot region;
a scope configured to measure, in an X-Y plane, a position of a substrate mark formed in each of a plurality of shot regions of the substrate held by the substrate chuck; and
a reference mark formed on the X-Y stage, wherein
the X-Y stage has a moving range allowing the dispenser to dispense resin on all shot regions of the substrate, and resin on each shot of the substrate and the mold to be pressed to each other, and
the reference mark is arranged at a position on the X-Y stage where the position can be measured within the moving range of the X-Y stage.

9. A method comprising:
forming a resin pattern on a shot region of a substrate;
processing the substrate, to which the resin pattern has been formed,
wherein the apparatus is an apparatus for pressing resin on a shot region of a substrate and a mold to each other to form a resin pattern on the shot regions of the substrate, the apparatus including:
a mold chuck;
an X-Y stage including a substrate chuck, resin on a shot region of the substrate held by the substrate chuck and the mold held by the mold chuck being pressed to each other in a Z-axis direction;
a dispenser configured to dispense the resin on the shot regions;
a scope configured to measure, in an X-Y plane, a position of a substrate mark formed in each of a plurality of shot regions of the substrate held by the substrate chuck; and
a reference mark formed on the X-Y stage, wherein in the xy plane, a center of the dispenser is disposed at a position deviated from a center of the mold chuck by a first distance (>0) in a direction, and a center of the reference mark is disposed at a position deviated, from a position deviated from a center of the substrate chuck by the first distance in the direction, in a direction opposite to the direction.
